(19) United States
(12) Patent Application Publication
(10) Pub. No.: US 2010/0162303 A1
(43) Pub. Date: Jun. 24, 2010

(54) SYSTEM AND METHOD FOR SELECTING AN OBJECT IN A VIDEO DATA STREAM

(76) Inventor: JEFFREY P. CASSANOVA, Villa Rica, GA (US)

Correspondence Address: AT&T Legal Department - Roebuck;Attn: Patent Docketing, One AT&T Way,, Room 2A-207, Bedminster, NJ, 07921, US

(21) Appl. No.: 12/342,376

(22) Filed: Dec. 23, 2008

(51) Int. Cl. H04N 5/445; H04N 7/173

(52) U.S. Cl. 725/37; 725/115

(57) ABSTRACT

A method for selecting an object in a video data stream is disclosed, the method including but not limited to receiving at a client device the video data stream; displaying the video data stream at the client device on a client device display; selecting a pixel location within a video data frame in the video data stream; associating the pixel location with an object in the video data frame; reading Meta data, associated with the object in the video data stream; and presenting based on the Meta data, information data associated with the object at the client device. A system and computer program product are also disclosed for selecting an object in a video data stream.

### BACKGROUND

1. Field of Disclosure

The disclosure relates to the field of video data distribution systems and more specifically to systems and methods for selecting an object from a video data stream.

2. Description of Related Art

Video data distribution systems typically send video data to client devices which receive and decode the video data from the video data distribution system. Content providers deliver content via broadcasts to a number of client devices and/or deliver content via on-demand processing based on requests received and content availability. A content provider typically encrypts and multiplexes the primary and alternative content in channels for transmission to various head ends. These signals are dc-multiplexed and transmitted to integrated receiver decoders (IRDs) which decrypt the content. These IRDs are client devices typically referred to as set top boxes (STBs) as they often sit on top of a home television which display video received by the STB from the data distribution system.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals.

FIG. 1 is a schematic depiction of a graphical representation on an illustrative embodiment of a client device display in an illustrative embodiment;

FIG. 2 is a schematic depiction of a graphical representation on an illustrative embodiment of a client device display in an illustrative embodiment;

FIG. 3 is a schematic depiction of a graphical representation on an illustrative embodiment of a client device display in an illustrative embodiment;

FIG. 4 is a data flow diagram showing an illustrative embodiment of data exchanged and process in a particular illustrative embodiment;

FIG. 5 is a schematic depiction of an data distribution system delivering data to a client device in an illustrative embodiment; and

FIG. 6 is a diagrammatic representation of a machine in the form of a computer system within which a set of instructions, when executed, may cause the machine to perform any one or more of the methodologies of the illustrative embodiment.

### DETAILED DESCRIPTION OF THE DISCLOSURE

In the following description, for purposes of explanation, numerous specific details are set forth in order to provide a thorough understanding of an embodiment of the present invention. It will be evident, however, to one skilled in the art that the present invention may be practiced without these specific details. This disclosure describes a system, method and computer program product for obtaining information about objects selected from a video data stream. The objects can be anything, including but not limited to an image or associated audible sound in a video data stream. The objects represents items of interest in the video stream including but not limited to objects such as actors, actresses, cars, scenery and clothing from a video data stream being displayed on a client device. The video data stream includes Meta data describing the objects that appear in the video data stream. In another embodiment the meta data is stored at a server and not included in the video data stream. Thus, a viewer can place a remote controlled cursor over an actor or actress in a video stream to obtain information about the actor or actress, such as their name, film history, etc.

In another embodiment the Meta data is not in the video data stream, but is stored on another server and the correct meta data to display (describing an object selected from the video data stream) are retrieved from the server side. For instance, in a particular embodiment, the client device does not have access to an MPEG 7 encoded video data stream having Meta data encoded within the MPEG 7 encoded video data stream. In a particular embodiment a client device (such as a cell phone or “IPHONE”™), which is telling the STB where to display a cursor, senses when an end user presses a button on the IPHONE and where the cursor is located on the TV screen when the button is pushed. Then when the end user presses the button on the remote control or on the client device (i.e., “click time”), the client device sends the coordinates of the cursor at click time to the server side for processing at the server. This server side knows when the end user device started the movie or TV program and also knows the frame rate of that movie so it can figure out what frame the movie is on when the cursor is clicked by the client device displaying the video data (display device) or a second client device acting as a cursor control which directs the cursor position in the video data stream displayed on the display client device. And on the server side, it also has a server side database of frame to content mapping. (e.g., at frame 55-78, at pixel locations defined by some region, is this item or actress). So the server will know the frame, and will get the cursor location from the iPhone or other client device, so the server will be able to figure out if the end user device was pointing at an identifiable object in the video data stream.

An article of clothing which an actor or actress is wearing in a video stream can also be selected by the cursor to obtain information data about the article of clothing. Another object appearing in a scene from a video stream, such as a car or mountain peak in the back ground of a scene can be selected by the cursor to obtain information data about the car or mountain. The information about the selected object can presented as displayed in a picture in picture (PIP) window on the display along with the video stream from which the object is selected or can be presented as announced from a loud speaker or other sound reproductive device on the client device or a peripheral in data communication with the client device. In another embodiment, an expandable region of pixels is displayed for enabling a user via the remote control to expand the expandable region of displayed pixels for inclusion of additional objects within object selection by the remote control for information data. In another embodiment, the video data stream is displayed on a first client device such as a television connected to a set top box, and information data is presented on a second end user device such as an IPHONE™. In another embodiment, the IPHONE™ is also used to move the cursor around a display of the video data stream on the STB end user device.

In another embodiment, a user can manipulate a remote control (RC) to draw a square or another closed geometric form around one or more objects displayed on the client device for presentation on the client device. A graphic object recognition function in the client device or server processor recognizes the closed geometric forms around the objects displayed at the client device. In another embodiment, a user can draw multiple closed geometric forms, such as circles and squares around multiple objects to include all objects in a request for information data to present on the client device. In another embodiment, an accelerometer-equipped remote control is manipulated with gestures to draw enclosing geometric forms around objects displayed on the client device to be included in a request for information. In another embodiment, an object from a video stream from a live event is selected for the information data presentation. In the live event, the Meta data included in the video stream is less specific because the live action is unscripted and unpredictable thus cannot be preprogrammed into the Meta data. For example, an image of Derek Jeter of the New York Yankees (NYY) can be selected as an object from a live video stream presentation of live event and combined with Meta data in the video data stream about the NYY to identify the object as an image of Derek Jeter. In another embodiment, the Meta data about the NYY includes a reference image or a pointer to a reference image of Derek Jeter for use in comparison of the reference image to the selected object in identifying the selected image as Derek Jeter.

In another embodiment, a musical icon such as a musical quarter note symbol is presented on the client display screen so that upon selection of the musical icon, an information message announcing the song title and composer or other data regarding the musical passage currently playing in the video data stream is presented audibly or visibly on the client device or a peripheral in data communication with the client device. The musical icon can be shaped like a musical quarter note or another musical symbol note. In another embodiment, a story line icon such as a triangle or another symbol is displayed on the client display and can be selected to cause the client device to present a plot line including only the object selected when the story line icon is selected. For example, a user could select actor Brad Pitt and actress Angelina Jolie within an expanded pixel region as objects on a video display and also select the story line icon. The client device processor would then monitor data and Meta data in the video data stream and present only those scenes containing both Brad Pitt and Angelina Jolie.

In another embodiment a method is disclosed for selecting an object in a video data stream, the method including but not limited to receiving at a client device, the video data stream from a server; displaying the video data stream at the client device on a client device display; selecting a region of pixel locations within a video data frame in the video data stream displayed on the client device; associating the region of pixel locations with at least two objects in the video data frame; reading Meta data associated with the at least two objects; and presenting based on the Meta data, information data associated with the at least two objects at the client device.

In another embodiment of the method, the Meta data is contained in one of the group consisting of the video data stream and a server data base, and wherein the selecting further includes but is not limited to selecting with a cursor displayed on the client device display, a first corner location for the region of pixel locations and expanding a rectangle defining the region of pixel locations starting at the first corner location defining the region of pixel locations by expanding the region of pixels by dragging the cursor to a second corner location for the region of pixel locations. In another embodiment of the method, the objects are located based on the region of pixel locations in a video frame displayed at the time of selecting the region of pixel locations. In another embodiment of the method, the method further includes but is not limited to presenting for display at the client device, a plot line of video frames associated with the objects selected in the video stream based on the Meta data associated with the objects.

In another embodiment of the method, the video stream is video data from a live event, the method further including but not limited to associating the objects from the video data stream with a reference image identifying an object from the live event to obtain additional information data about the objects for display on the client device display. In another embodiment of the method, presenting further includes but is not limited to an act selected from the group consisting of displaying the information data on the client device display and audibly announcing the information data at the client device. In another embodiment of the method, the presenting information data is performed on another client device other than the client device display. In another embodiment of the method, the object is a data item selected from the group consisting of an actor, a location, an article of clothing and a music icon associated with a melody included in the video data stream. In another embodiment of the method, the information data is selected from a data base using the Meta data as a search term for searching the data base. In another embodiment of the method, the information data is downloaded from an IPTV system server and is stored on a database at the client device.

In another embodiment of the a computer readable medium is disclosed containing computer program instructions to select an object in a video data stream, the computer program instructions including but not limited to instructions to receive at a client device, the video data stream from a live event; instructions to display the video data stream at the client device on a client device display; instructions to select a region of pixel locations within a video data frame in the video data stream; instructions to associate the pixel location with an object in the video data frame; instructions to associate the object from the video data stream with a reference image to identify the object from the live event in the video data stream to obtain additional information data about the object for display on the client device display. In another embodiment of the medium the instructions to select a region of pixels further include but are not limited to instructions to select with a cursor displayed on the client device display, a first corner location for the region of pixels and expanding a rectangular region of pixels starting at the first corner location and instructions to define the region of pixels by tracking the cursor as it is dragged to a second corner location for the region of pixels. In another embodiment of the medium, the computer instruction further include but are not limited to instructions to present for display at the client device, a plot line of video frames associated with the object selected in the video stream based on the Meta data in the video stream associated with the object. In another embodiment of the medium, the information data is selected from a data base using the Meta data as a search term for searching the data base.

In another embodiment a system for selecting an object in a video data stream is disclosed, the system including but not limited to a computer readable medium; a processor in data communication with the computer readable medium; a first client device interface on the processor to receive the video data stream; a second client device interface to send data for display the video data stream at the client device on a client device display; a third client device interface to receive data selecting a pixel location within a video data frame in the video data stream for associating the pixel location with an object in the video data frame; a fourth client device interface for reading Meta data associated with the object in the video data frame; and a fifth interface to receive a plot line of video frames based on the Meta data associated with the object. In another embodiment of the system, the system further includes but is not limited to a sixth interface to receive data defining a region of pixels associated with the pixel location. In another embodiment of the system, the defining further comprises selecting with a cursor displayed on the client device display, a first corner location for the region of pixels and expanding a rectangle starting at the first corner location defining the region of pixels surrounding at least two objects in the video stream by dragging the cursor to a second corner location for the region of pixels.

In another embodiment a method for sending a video data stream is disclosed, the method including but not limited to sending from a server to an end user client device, the video data stream; receiving at the server from the client device, selection data indicating a pixel location associated with an object in the video data frame; reading at the server, Meta data associated with the object in the video data frame; and sending from the server to the client device a plot line of video data frames including the object for display at the end user client device. In another embodiment a system for sending an object in a video data stream is disclosed, the system including but not limited to a computer readable medium at a server; a processor at the server in data communication with the computer readable medium; a first server interface in data communication with the processor to send to an end user client device the video data stream; a second server interface in data communication with the processor to receive data selecting a region of pixel locations within a video data frame in the video data stream for associating the region of pixel locations with at least two objects in the video data frame; a third server interface in data communication with the processor for reading Meta data associated with the objects selected in the video data stream; and a fourth server interface in data communication with the processor to send based on the Meta data associated with the objects, information data associated with the objects to the client device.

In another embodiment a computer readable medium is disclosed containing computer program instructions that when executed by a computer send a video data stream, the computer program instructions comprising instructions to send from a server to an end user client device, the video data stream from a live event; instructions to receive from the client device, data indicating a region of pixel locations within a video data frame in the video data stream from the live event; instructions to associate the region of pixels with an object in the video data frame; instructions to read Meta data, associated with the object in the video data stream; instructions to associate the object with a reference image based on the Meta data; and instructions to send to the client device based on the reference image, information data associated with the object from the live event for display at the client device.

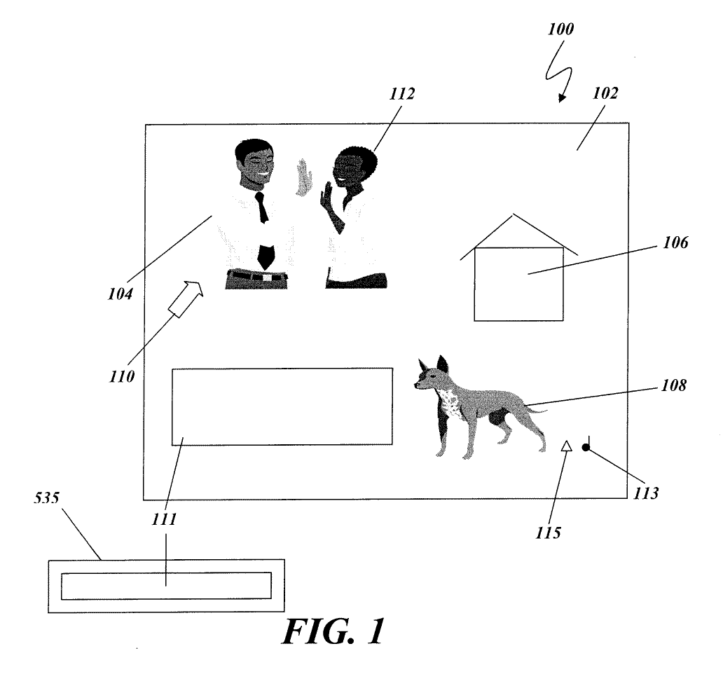

Turning now to FIG. 1, an illustrative embodiment 100 of a client device display 102 is depicted. As shown in FIG. 1, objects 104, 112, 106 and 108 appear on the display and can be selected by cursor 110 for information to be presented about the object. A plot line icon 115 and musical icon 113 are presented for selection by a user with data communication access to the client device display. In FIG. 1, object 104 for example actor Brad Pitt is selected by cursor 110. In an illustrative embodiment, the client device processor obtains the current video frame in the video stream from a time expired in the video stream presentation from start time of the video stream presentation and determines a pixel location for the cursor within the determined video frame at the cursor tip position or within a region of pixels. The client device processor then determines from the Meta data associated with the video frame and pixel location and determines the identity of the selected object from the Meta data. The Meta data may include key words or reference images that are used as search terms in a data base at the client device or IPTV system to obtain additional information data associated with the selected object.

Information data associated with and from the Meta data about the selected object is presented graphically in a PIP display 111 on the client device display screen or announced audibly from a sound reproduction device built in to the STB or a sound reproduction device on a peripheral in data communication with the STB. In another embodiment a second client device, for example a mobile phone 533, such as an IPHONE is used as a remote control to control the cursor position and select objects on a first client device display, for example a television connected to the set top box. When an object is selected, a cursor position and time are sent back to the server which associates the cursor position and time with an object in the video data stream. The information data 111 can also be displayed on the mobile phone display 533 instead of the client device display.

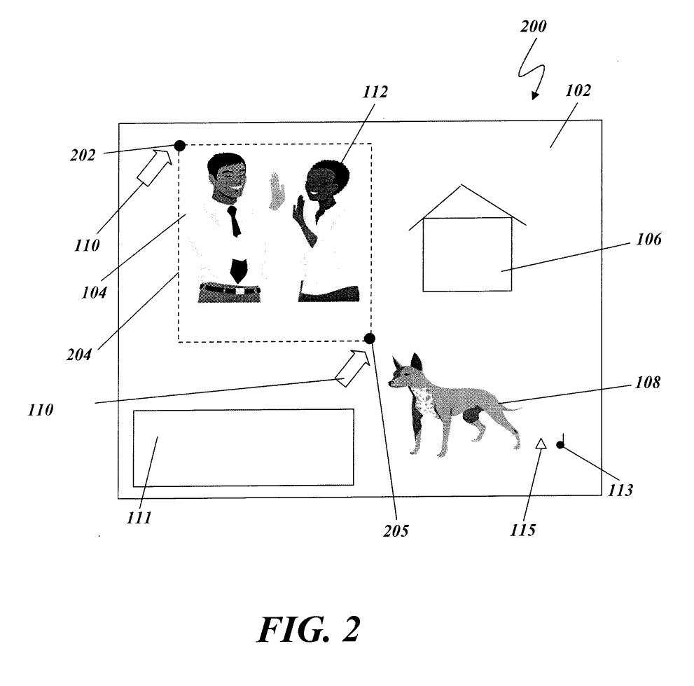

Turning now to FIG. 2, in another embodiment, an expanded region of pixels 204 as shown in FIG. 2 as a dashed-line forming a rectangle is defined by a user remote control on a client device display. The objects within the region of pixels are considered in presenting information message on a client device. To define the region of pixels the cursor 110 is used to define a first corner 202 of the region of pixels. By depressing the RC cursor button and dragging the RC cursor across the client device display screen, the region of pixels expands in height and width until the RC cursor defines a second corner 205 of the region of pixels. By expanding the region of pixels a user can select both objects 104 and 112 for presentation of information in PIP 111, announcement of the information on a sound reproduction device or a story line presentation by selecting plot line icon 115.

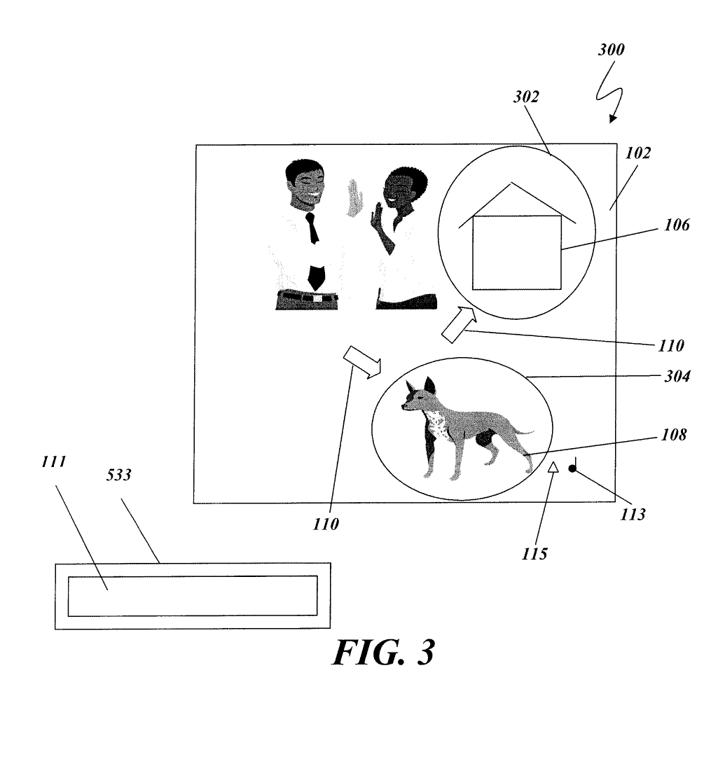

Turning now to FIG. 3, a graphical representation of another illustrative embodiment 300 is shown in which separate closed geometric forms 302 and 304 such as a circle or square are drawn around each object 106 and 108 respectively displayed on a client device display such as a television connected to a set top box. In this embodiment a house 110 and dog 108 displayed on a television are selected for an information data presentation as a display or audible announcement at another client device 533 such as a mobile phone.

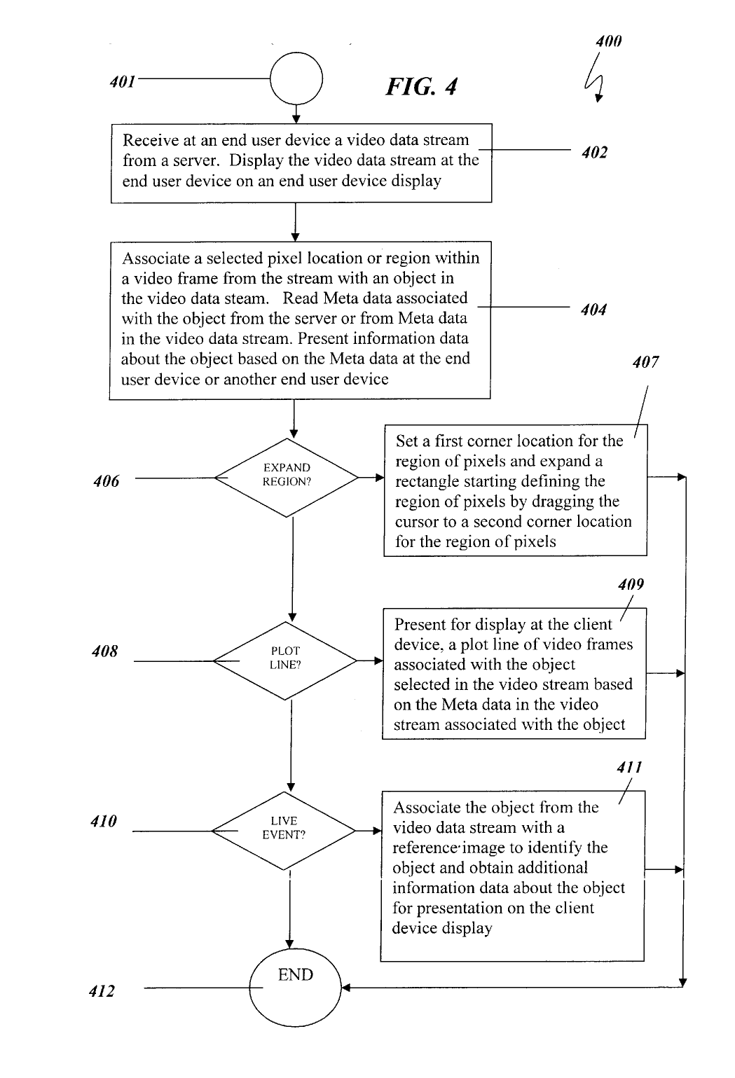

Turning now to FIG. 4, FIG. 4 depicts a flow chart of functions performed in a particular illustrative embodiment. FIG. 4 is one example of functions that are performed in a particular embodiment, however, no mandatory order of execution or mandatory functions are implied or dictated by FIG. 4, as in other particular embodiments, a different order of execution may be performed and particular functions shown in FIG. 4 are left out of execution entirely. The flow chart starts at terminal 401 and proceeds to bock 402. At block 402 an illustrative embodiment receives at a client device, such as an end user device including but not limited to a set top box or cell phone, the video data stream. The client device displays the video data stream on a client device or end user device display. At block 404 an illustrative embodiment associates a selected pixel location or region within a video frame from the stream with an object in the video data steam. Read Meta data associated with the object from the server or from Meta data in the video data stream. Present information data about the object based on the Meta data at the end user device or another end user device.

At block 406 an illustrative embodiment determines if an end user is expanding a region of pixels. If an end user is expanding the region of pixels, an illustrative embodiment proceeds to block 407 and sets a first corner location for the region of pixels and expand a rectangle starting defining the region of pixels by dragging the cursor to a second corner location for the region of pixels. If an end user is not expanding the region of pixels in decision block 406, an illustrative embodiment proceeds to block 408 and determines if an end user has requested a plot line. If an end user has requested a plot line, an illustrative embodiment proceeds to block 409 and present for display at the client device, a plot line of video frames associated with the object selected in the video stream based on the Meta data in the video stream associated with the object.

If an end user has not request a plot line an illustrative embodiment proceeds from decision block 408 to decision block 410 and determines if the video data is from a live event. If at decision block 410 the video data is from a live event, an illustrative embodiment proceeds to block 411 and associates the object from the video data stream with a reference image to identify the object and obtain additional information data about the object for presentation on the client device display. If at decision block 410 the video data is not from a live event, an illustrative embodiment proceeds to terminal 412 and exits.

In another embodiment, presenting information data further includes but is not limited to displaying the information data on the client device display or audibly announcing the information data at the client device. In another illustrative embodiment, the object is a data item selected from the group consisting of an actor, a location, an article of clothing and a musical icon associated with a melody or musical passage from the video data stream.

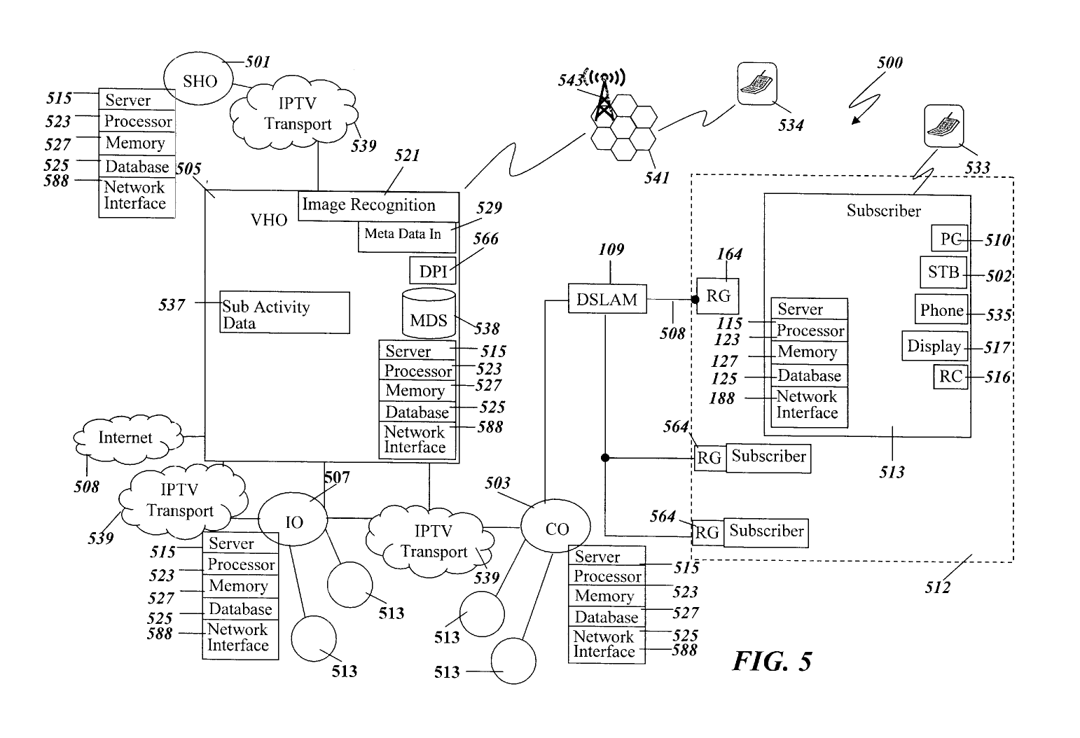

Turning now to FIG. 5, in internet protocol television (IPTV) system is shown delivering internet protocol (IP) video television data to a client device. The IPTV system 500 delivers video data including but not limited to content and Meta data to subscriber house holds 513 and associated end user devices (referred to herein as client devices) which may be inside or outside of the household. The video data further includes but is not limited to descriptions of the video content which are embedded in the video data stream such as Meta data in an MPEG 7 data stream. In another embodiment the Meta data and descriptions are not included in the video data stream but are stored at the server. A pixel location for an object within a video data frame when a user at an end user device clicks on the object are used to access the Meta data at the server using the click time and pixel location within the frame to locate Meta data associated with a selected object in the video data stream. The Meta data can be preprogrammed and can include but are not limited to text, audio, imagery, reference imagery and video data added to the Meta data. The Meta data are inserted by a video source in the IPTV system or are generated from an aural recognition and pattern recognition analysis of the video data stream and inserted into the video data stream. Video data from live events can be analyzed against Meta data reference imagery, reference text and reference audio to generate or find in a database based on a search using key words or reference imagery from the Meta data which are then inserted into the video data stream. Thus, when a client device is tracking a plot line for Brad Pitt, any image text or audio reference to Brad Pitt, including but not limited to a voice pattern matching, which can be utilized to identify a video scene which includes Brad Pitt will be used in tracking a plot line for Brad Pitt for presentation of those scenes including Brad Pitt at a client device.

Meta data are inserted by the Meta data server 538. In the IPTV system, IPTV channels are first broadcast in an internet protocol (IP) data format from a server at a super hub office (SHO) 501 to a regional or local IPTV video hub office (VHO) server 503, to an intermediate office (IO) server 507 and to a central office (CO) 503. The IPTV system 500 includes a hierarchically arranged network of servers wherein a particular embodiment the SHO transmits video and advertising data to a video hub office (VHO) 503 and the VHO transmits to an end server location close to a subscriber, such as a CO server 503 or IO 507. In another particular embodiment, each of the SHO, VHO, CO and IO are interconnected with an IPTV transport 539. The IPTV transport 539 may consist of high speed fiber optic cables interconnected with routers for transmission of internet protocol data. The IPTV servers also provide data communication for Internet and VoIP services to subscribers.

Actively viewed IPTV channels are sent in an Internet protocol (IP) data multicast group to access nodes such as digital subscriber line access multiplexer (DSLAM) 509. A multicast for a particular IPTV channel is joined by the set-top boxes (STBs) at IPTV subscriber homes from the DSLAM. Each SHO, VHO, CO, IO and STB includes a server 515, processor 523, a memory 527, network interface 588 and a database 525. Analysis of the video data for advertising data key insertion is performed by processor 523 at the VHO. The network interface functions to send and receive data over the IPTV transport. The CO server delivers IPTV, Internet and VoIP content to the subscriber via the IO and DSLAM. The television content is delivered via multicast and television advertising data via unicast or multicast depending on a target television advertising group of end user client subscriber devices.

In another particular embodiment, subscriber devices, also referred to herein as users and as end user devices, are different stationary and mobile devices, including but not limited to, wire line phones 535, portable phones 533, lap top computers 518, personal computers (PC) 510 and STBs 502, 519 communicate with the communication system, i.e., IPTV system through residential gateway (RG) 564 and high speed communication lines such as IPTV transport 539. In another particular embodiment, DPI devices 566 inspect data VoIP, Internet data and IPTV video, commands and Meta data (multicast and unicast) between the subscriber devices and the IPTV system severs. DPI devices are used in analysis of the video data for insertion of the Meta data based on Meta data stored in the data base 525. In a particular embodiment the video data stream is analyzed for imagery, text and audio instances of a particular object selected in the video data stream, such as an actress, e.g. Angelina Jolie, adding Meta data descriptions as images of Angelina Jolie are detected are detected by image recognition devices 521 associated with the DPI devices. Meta data describing the instances found by the DPI device are inserted into the video data stream for presentation to a client device. Image, text and sound recognition functions are used to analyze video data for insertion of Meta data describing the video, in association with the DPI devices. Textual and aural key words and imagery found in the video data stream are inspected by the DPI devices 566 and image recognition functions 521 in the processors 523 in the communication system servers and are used as Meta data describing the objects in the video data stream.

In another particular embodiment, the end client user devices or subscriber devices include but are not limited to a client user computer, a personal computer (PC) 510, a tablet PC, a set-top box (STB) 502, a Personal Digital Assistant (PDA), a cellular telephone 534, a mobile device 534, a palmtop computer 534, a laptop computer 510, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. In another particular embodiment, a deep packet inspection (DPI) device 524 inspects multicast and unicast data stream, including but not limited to VoIP data, Internet data and IPTV video, commands and Meta data between the subscriber devices and between subscriber devices and the IPTV system severs.

In another illustrative embodiment data are monitored and collected whether or not the subscriber devices are in the household 513 or the devices are mobile devices 534 outside of the household. When outside of the household, subscriber mobile device data is monitored by communication system (e.g. IPTV) servers which associate a user profile with each particular subscriber's device. In another particular embodiment, user profile data including subscriber activity data such as communication transactions are inspected by DPI devices located in a communication system, e.g., IPTV system servers. These communication system servers route the subscriber profile data to a VHO in which the profile data for a subscriber are stored for processing in determining which objects and Meta data would be of interest to a particular end user and which objects in a video stream should be described with the Meta data. If a user has an interest in a particular luxury automobile then instances of imagery, text or audio data occurring in the video data stream can be described in the Meta data accompanying the video data stream for presentation to a particular user having an interest in the particular luxury automobile. The same or similar Meta data can be targeted to other subscriber's in a demographic sector having sufficient income to purchase the particular luxury automobile.

As shown in FIG. 5 advertising sub groups 512 (comprising a group of subscriber house holds 513) receive Meta data and in video data stream from IO server 507 via CO 503 and DSLAM 509 at STB 502. Individual households 513 receive the video data stream including the Meta data at set top box 502 or one of the other subscriber devices. More than one STB (see STB1 502 and STB2 519) can be located in an individual household 513 and each individual STB can receive a separate multicast or unicast advertising stream on IPTV transport 539 through DSLAM 509. In another particular illustrative embodiment separate and unique Meta data are presented at each set top box (STB) 502, 519 tailored to target the particular subscriber watching television at that particular STB. Each STB 502,519 has an associated remote control (RC) 516 and video display 517. The subscriber via the RC selects channels for a video data viewing selection (video programs, games, movies, video on demand) and places orders for products and services over the IPTV system 500. Meta data are generated and inserted at the VHO and sent to client devices. In another embodiment, Meta data are generated at the end user devices by processors at the end user devices. Meta data at the end user devices can then be selected for display by the end user devices based on processing of the Meta data described herein.

FIG. 5 depicts an illustrative communication system, including but not limited to a television Meta insertion system wherein Meta data can be inserted at an IPTV (SHO, VHO, CO) server or at the end user client subscriber device, for example, an STB, mobile phone, web browser or personal computer. Meta data can be inserted for selected objects appearing in video data, into an IPTV video stream via Meta data insertion device 529 at the IPTV VHO server 505 or at one of the STBs 502, 509. The IPTV servers include an object Meta data server 538 and an object Meta data database 539. The object Meta data is selected by Meta data object selection element 529 from the object Meta data database 525 based on a subscriber profile indicating objects of interest and delivered by the VHO object Meta data server 538 to the IPTV VHO server 515. An SHO 501 distributes data to a regional VHO 503 which distributes the video data stream and Meta data to local COs 505 which distribute data via IO 507 to a digital subscriber access line aggregator multiplexer (DSLAM) access node to subscriber devices such as STBs 502, 519, PC 510 wire line phone 535, mobile phone 533 etc. Objects appearing in the video data stream are also selected for Meta data description based on the community profile for users in the community and sent to a mobile phone or computer associated with the subscriber or end user devices in the community. The community subscriber profile is built based on a community of subscribers' IPTV, Internet and VoIP activity.

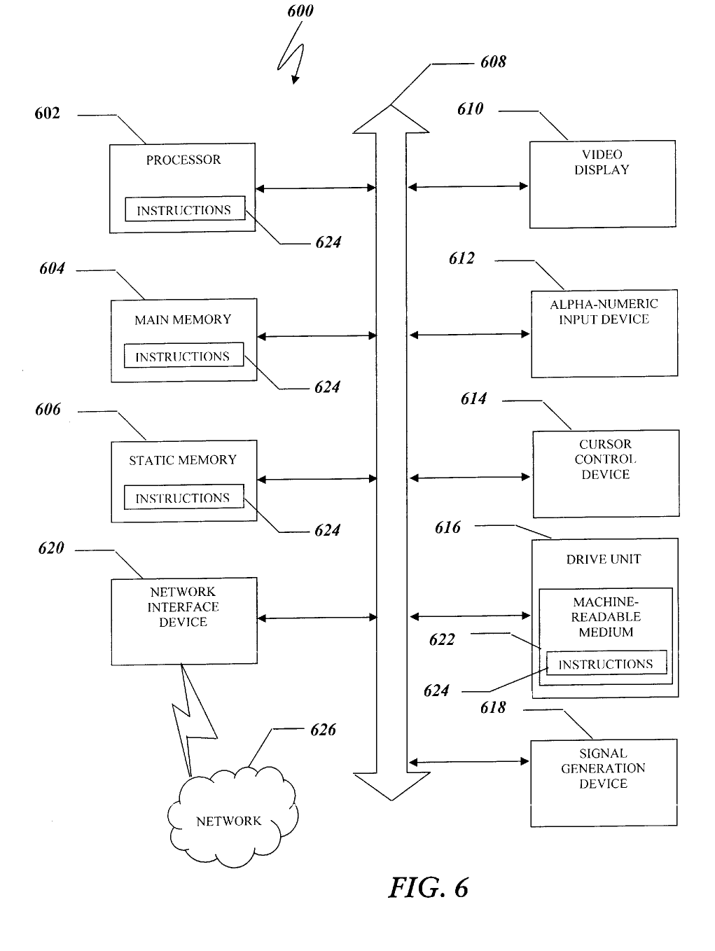

Turning now to FIG. 6, FIG. 6 is a diagrammatic representation of a machine in the form of a computer system 600 within which a set of instructions, when executed, may cause the machine, also referred to as a computer, to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the illustrative includes broadly any electronic device that provides voice, video or data communication. Further, while a single machine is illustrated, the terms “machine” and “computer” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a computer-readable and machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a computer-readable and machine-readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the terms “machine-readable medium” and “computer-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present illustrative embodiment, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

1. A method for selecting an object in a video data stream, the method comprising:
receiving at a client device, the video data stream from a server;
displaying the video data stream at the client device on a client device display;
selecting a region of pixel locations within a video data frame in the video data stream displayed on the client device;
associating the region of pixel locations with at least two objects in the video data frame;
Reading Meta data associated with the at least two objects; and
presenting based on the Meta data, information data associated with the at least two objects at the client device.

2. The method of claim 1, wherein the Meta data is contained in one of the group consisting of the video data stream and a server data base, and wherein the selecting further comprises selecting with a cursor displayed on the client device display, a first corner location for the region of pixel locations and expanding a rectangle defining the region of pixel locations starting at the first corner location defining the region of pixel locations by expanding the region of pixels by dragging the cursor to a second corner location for the region of pixel locations.

3. The method of claim 1, wherein the objects are located based on the region of pixel locations in a video frame displayed at the time of selecting the region of pixel locations.

4. The method of claim 1, the method further comprising:
presenting for display at the client device, a plot line of video frames associated with the objects selected in the video stream based on the Meta data associated with the objects.

5. The method of claim 1, wherein the video stream is video data from a live event, the method further comprising:
associating the objects from the video data stream with a reference image identifying an object from the live event to obtain additional information data about the objects for display on the client device display.

6. The method of claim 1, wherein presenting further comprises an act selected from the group consisting of displaying the information data on the client device display and audibly announcing the information data at the client device.

7. The method of claim 6, wherein the presenting information data is performed on another client device other than the client device display.

8. The method of claim 1, wherein the object is a data item selected from the group consisting of an actor, a location, an article of clothing and a music icon associated with a melody included in the video data stream.

9. The method of claim 1, wherein the information data is selected from a data base using the Meta data as a search term for searching the data base.

10. The method of claim 1, wherein the information data is downloaded from an IPTV system server and is stored on a database at the client device.

11. A computer readable medium containing computer program instructions to select an object in a video data stream, the computer program instructions comprising instructions to receive at a client device, the video data stream from a live event; instructions to display the video data stream at the client device on a client device display; instructions to select a region of pixel locations within a video data frame in the video data stream; instructions to associate the pixel location with an object in the video data frame; instructions to associate the object from the video data stream with a reference image to identify the object from the live event in the video data stream to obtain additional information data about the object for display on the client device display.

12. The medium of claim 11, wherein the instructions to select a region of pixels further comprise instructions to select with a cursor displayed on the client device display, a first corner location for the region of pixels and expanding a rectangular region of pixels starting at the first corner location and instructions to define the region of pixels by tracking the cursor as it is dragged to a second corner location for the region of pixels.

13. The medium of claim 11, the computer instruction further comprising instructions to present for display at the client device, a plot line of video frames associated with the object selected in the video stream based on the Meta data in the video stream associated with the object.

14. The medium of claim 11, wherein the information data is selected from a data base using the Meta data as a search term for searching the data base.

15. A system for selecting an object in a video data stream, the system comprising:
a computer readable medium;
a processor in data communication with the computer readable medium;
a first client device interface on the processor to receive the video data stream;
a second client device interface to send data for display the video data stream at the client device on a client device display;
a third client device interface to receive data selecting a pixel location within a video data frame in the video data stream for associating the pixel location with an object in the video data frame;
a fourth client device interface for reading Meta data associated with the object in the video data frame; and
a fifth interface to receive a plot line of video frames based on the Meta data associated with the object.

16. The system of claim 15, the system further comprising:
a fifth interface to receive data defining a region of pixels associated with the pixel location.

17. The system of claim 16, wherein the defining further comprises selecting with a cursor displayed on the client device display, a first corner location for the region of pixels and expanding a rectangle starting at the first corner location defining the region of pixels surrounding at least two objects in the video stream by dragging the cursor to a second corner location for the region of pixels.

18. A method for sending a video data stream, the method comprising:
Sending from a server to an end user client device, the video data stream;
Receiving at the server from the client device, selection data indicating a pixel location associated with an object in the video data frame;
Reading at the server, Meta data associated with the object in the video data frame; and
Sending from the server to the client device a plot line of video data frames including the object for display at the end user client device.

19. A system for sending an object in a video data stream, the system comprising:
a computer readable medium at a server;
a processor at the server in data communication with the computer readable medium;
a first server interface in data communication with the processor to send to an end user client device the video data stream;
a second server interface in data communication with the processor to receive data selecting a region of pixel locations within a video data frame in the video data stream for associating the region of pixel locations with at least two objects in the video data frame;
a third server interface in data communication with the processor for reading Meta data associated with the objects selected in the video data stream; and
a fourth server interface in data communication with the processor to send based on the Meta data associated with the objects, information data associated with the objects to the client device.

20. A computer readable medium containing computer program instructions that when executed by a computer send a video data stream, the computer program instructions comprising instructions to send from a server to an end user client device, the video data stream from a live event; instructions to receive from the client device, data indicating a region of pixel locations within a video data frame in the video data stream from the live event; instructions to associate the region of pixels with an object in the video data frame; instructions to read Meta data, associated with the object in the video data stream; instructions to associate the object with a reference image based on the Meta data; and instructions to send to the client device based on the reference image, information data associated with the object from the live event for display at the client device.
